(19) United States
(12) Patent Application Publication
(10) Pub. No.: US 2003/0170062 A1
(43) Pub. Date: Sep. 11, 2003

(54) Mountable integral keyboard

(76) Inventor: Walter T. Kochanski, Kendallville, IN (US)

Correspondence Address: TAYLOR & AUST, P.C., 142 S. Main St., P.O. Box 560, Avilla, IN, 46710, US

(21) Appl. No.: 10/390,469

(22) Filed: Mar. 17, 2003

Related U.S. Application Data
(63) Continuation-in-part of application No. 09/746,292, filed on Dec. 21, 2000, now Pat. No. 6,533,479.

(51) Int. Cl. B41J 5/14

(52) U.S. Cl. 400/472

(57) ABSTRACT

A keyboard assembly including a keyboard and an attachment assembly detachably coupled directly to the keyboard and couplable to a structural member, the attachment assembly completely supporting the keyboard.

### CROSS REFERENCE TO RELATED APPLICATIONS

This is a continuation-in-part of U.S. patent application Ser. No. 09/746,292, “INTEGRAL KEYBOARD/TRAY/WRIST REST”, Filed Dec. 21, 2000.

### BACKGROUND OF THE INVENTION

1. Field of the Invention

The present invention relates to a computer workstation, and, more particularly, to a keyboard connection to a computer workstation.

2. Description of the Related Art

A computer workstation often includes a keyboard tray for supporting a computer keyboard. The keyboard, mouse pad and mouse are supported by and are freely slidable across the upper surface of the keyboard tray. A problem is that the positions of the keyboard and mouse pad must be frequently adjusted by the user in order to compensate for the sliding of the keyboard and mouse pad on the upper surface of the keyboard tray. Another problem is that the cords leading from the keyboard and mouse often become undesirably placed as the keyboard and mouse slide across the keyboard tray. This may lead to the cords being snagged, thereby pulling the keyboard and mouse off of the keyboard tray, which can result in damage to the mouse and keyboard. Yet another problem is that the sliding of the keyboard across the keyboard support can cause squeaking or other irritating sounds which add to the noise level of the office environment.

Economic considerations, primarily due to the competitive nature of computer related items, has lead to the current configuration of computer ancillary peripheral equipment. Keyboards in particular are such that they are essentially a throw away item if they malfunction. Keyboards are generally supported by a substantially flat surface and due to that support the keyboard needs only the strength to functionally hold the keys in an operating position. Weight transferred to the keyboard from an operator is directly transferred to the flat surface. A problem with this dependence, of the keyboard on a flat surface, is that the keyboard has little strength to be supported in a manner other than on a flat surface. Such a weakness is easily demonstrated by simply flexing the keyboard with two hands.

What is needed in the art is a keyboard assembly that is supported without the need for a tray.

### SUMMARY OF THE INVENTION

The present invention provides an integral support for a keyboard, that attaches and detaches from a work surface with a quick-connect coupler.

The invention comprises, in one form thereof, a keyboard assembly including a keyboard and an attachment assembly. The attachment assembly is detachably coupled directly to the keyboard and couplable to a structural member. The attachment assembly completely supports the keyboard.

An advantage of the present invention is that the keyboard is directly supported without a separate support structure.

Another advantage of the present invention is that the keyboard and mouse pad are in a fixed position, and do not slide around on a keyboard support surface.

Still another advantage is that the present invention occupies less space within a work cubical than does a separate keyboard, mouse pad and keyboard tray.

Yet another advantage is that the keyboard cord can be placed in a fixed position, thereby preventing the cord from getting snagged.

A further advantage is a reduction in the number of required components and, thus, a reduction in their associated costs.

A still further advantage is that the keyboard is strengthened so as to be supported by an attachment assembly, thereby resulting in a more durable keyboard.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of one embodiment of a keyboard assembly of the present invention;

FIG. 2 is a top view of the integral keyboard device of FIG. 1;

FIG. 3 is a side view similar to FIG. 1 illustrating the keyboard assembly of the present invention for use with a laptop computer;

FIG. 4 is an exploded perspective view of another embodiment of a keyboard assembly of the present invention; and

FIG. 5 is an exploded perspective view of another embodiment of a keyboard assembly of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

Referring now to the drawings, and more particularly to FIG. 1, there is shown one embodiment of a keyboard assembly 10 of the present invention, including an integral keyboard device 12 and an attachment assembly 14. Attachment assembly 14 is attached to an underside 16 of a desk top 18 having a work surface 20. Attachment assembly 14 includes a quick-connect coupler 22, a mounting arm 24, a pair of mounting brackets 26 and a pair of tracks 28, one of which is shown.

Integral keyboard device 12 includes a keyboard pad 30, a keyboard pad support 32, a wrist rest 34, a mouse pad 36 and an indentation or “mouse house” 38. A communication cord 40 is attached to integral keyboard device 12 and carries data which is dependent upon the actuation of keyboard pad 30 by a user, as is well known. Keyboard pad 30 includes a plurality of rows and columns of keys 42, as is also well known. Keyboard pad support 32 is in the form of a plastic tray that supports keyboard pad 30. Keyboard pad support 32 is integrally formed with pad 30 and with all other components of integral keyboard device 12.

Wrist rest 34 is an elongate pad extending along the length of keyboard pad 30. As best seen in FIG. 1, an upper surface 44 of wrist rest 34 is positioned above an upper surface 46 of keyboard pad support 32. Thus, wrist rest 34 supports a user's wrists or palms at a level above upper surface 46 of keyboard pad support 32. Mouse pad 36 provides a surface on which a computer mouse can be operated.

Indentation 38 provides an area in which a computer mouse can be stored and retained while not in use. Indentation 38 may be in communication with an optional channel 48 in which a cord of a computer mouse may be stored and retained. Alternatively, the cord of the computer mouse may be routed through the body of keyboard pad support 32 and through cord 40.

Quick-connect coupler 22 is a universal attachment that can be quickly and easily snapped onto integral keyboard device 12. Actuation of a button or lever (not shown) releases integral keyboard device 12 from quick-connect coupler 22 and allows device 12 to be detached from coupler 22.

A first end of mounting arm 24 is attached to quick-connect coupler 22. A second end of mounting arm 24 is pivotally attached to mounting brackets 26 at pivot points 50, only one of which is shown. More particularly, mounting arm 24 can pivot clockwise or counterclockwise about pivot points 50 in the plane of the page of FIG. 1. Mounting arm 24 includes a channel 52 in which cord 40 can be retained, thereby preventing snagging of cord 40. Channel 52 can have one open side through which cord 40 can be inserted into channel 52. Alternatively, channel 52 can be in the form of a through channel, i.e., channel 52 can be enclosed throughout 360° and have two open ends through which cord 40 is threaded.

Tracks 28 each slidably retain a respective one of mounting brackets 26. That is, each mounting bracket 26 can be slid within tracks 28 in the directions of double arrow 54 as a result of the user pushing integral keyboard device 12 toward desk top 18 or pulling integral keyboard device 12 away from desk top 18. Tracks 28 are rigidly affixed to underside 16 of desk top 18.

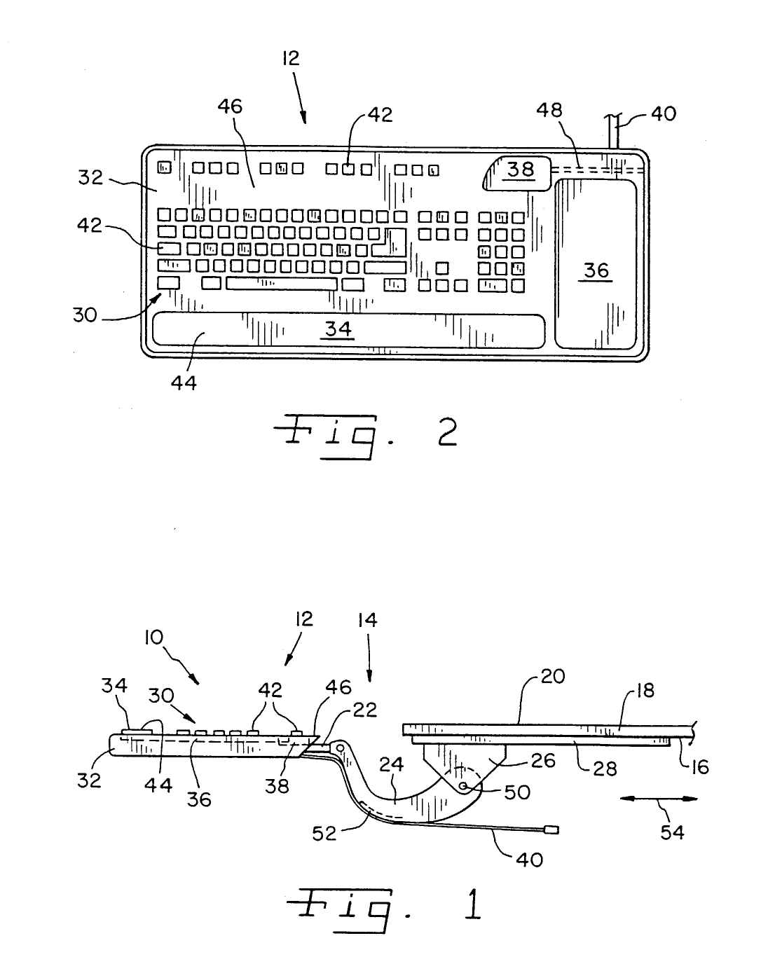

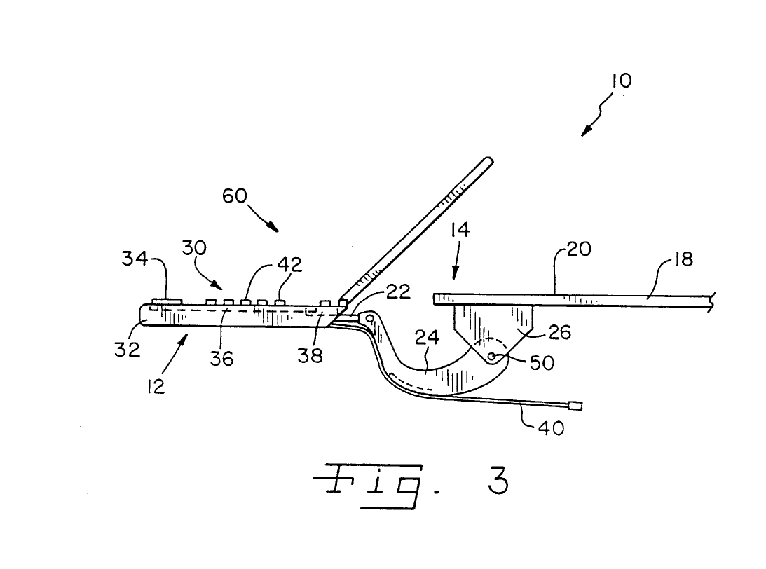

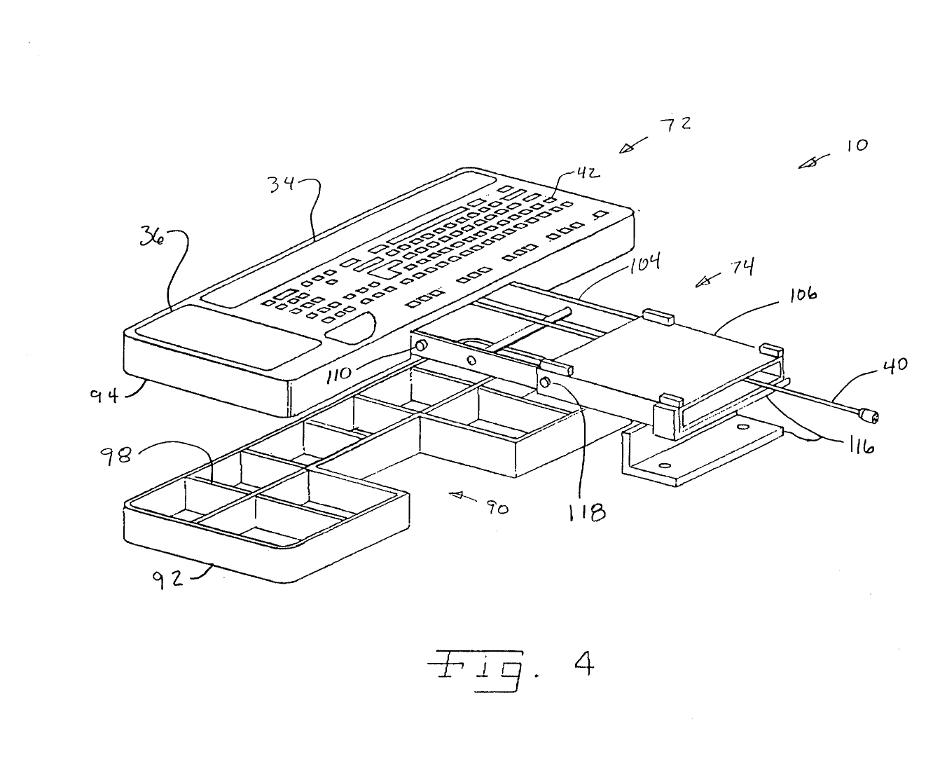

Integral keyboard device 12 is shown in FIG. 2 as being in the form of a keyboard input device for inputting data into a separate computer. However, it is to be understood that the integral keyboard device of the present invention may also be in the form of a laptop computer 60, as shown in FIG. 3.

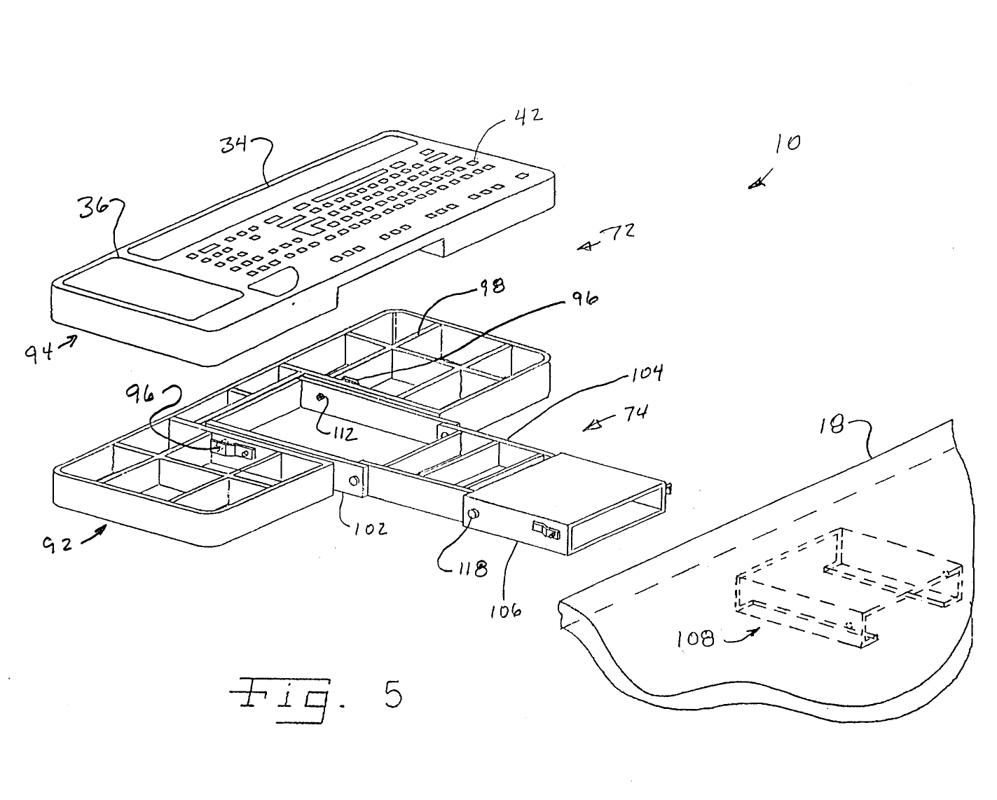

Now, additionally referring to FIGS. 4 and 5, there is shown another embodiment of keyboard assembly 10 including an integral keyboard device 72 and an attachment assembly 74.

Keyboard device 72, also known as a data input device 72, includes a receiving channel 90, a substructure 92 and an upper structure 94. Receiving channel 90 interacts with attachment assembly 74 to detachably connect keyboard device 72 thereto. Along the sides of receiving channel 90 are biased detents 96, in the form of spring fingers 96. Biased detents 96 interact with receiving points 112 or indentations 112 on attachment assembly 74 to removably connect keyboard device 72 to attachment assembly 74. Biased detents 96 may alternatively be located on attachment assembly 74, which would interact with receiving points along receiving channel 90. Biased detents 96 may also be in the form of spring loaded protrusions and may be integral with substructure 92, upper structure 94 or attachment assembly 74.

Substructure 92 and upper structure 94 of keyboard device 72 interact to form an integral strengthened keyboard unit. Substructure 92 and upper structure 94 are connected by fasteners or in a snap together manner. Substructure 92 includes ribs 98 to provide strength so that keyboard device 72 can be directly coupled with attachment assembly 74. This advantageously allows keyboard 72 to be directly supported thereby eliminating the need for a keyboard to be accommodated on a shelf, drawer, tray or space on desktop 18. The strength of keyboard device 72 is needed to accommodate loads that can be applied to it on its edges and corners, which are remote from the support that is available proximate to attachment assembly 74. Such loads often come from the pressure of forearms on wrist rest 34 and the placement of an elbow on mouse pad 36. The placing of an elbow on a surface such as on keyboard 72 transfers approximately 30 pounds of force. If an operator places an elbow on mouse pad 36 to then support his/her head on the palm of the hand, a force of 50 pounds is often transferred to this remote portion of keyboard device 72. Loads of an even greater intensity are periodically placed on keyboard device 72 when an operator grasps the edges of keyboard device 72 as an aid in standing from a sitting position in a chair. Other, even greater loads are contemplated if an person leans or partially sits on keyboard device 72 or uses keyboard device 72 as a lifting point in an attempt to move desk top 18.

Attachment assembly 74 is coupled to a structural member 18 such as desk top 18 having a work surface 20. Structural member 18 may be part of a work station, a desk or a roll around computer station. Attachment assembly 74 includes a quick-connect coupler 102, a mounting arm 104, a mounting bracket 106 and a track 108. Quick-connect coupler 102, similar to quick-connect coupler 22, is an attachment that can be quickly and easily snapped onto integral keyboard device 72. Even though attachment assembly 74 is depicted as coupling to an internal surface of keyboard device 72, keyboard device 72 may alternatively include a protrusion that extends from keyboard device 72 to which attachment assembly 74 is coupled in a detachable manner. The protrusion is coupled with the internal structural portion of keyboard device 72, such as ribs 98, to thereby effectively receive support from attachment assembly 74.

In one embodiment, quick-connect coupler 102 includes a button 110, which when activated releases integral keyboard device 72 from quick-connect coupler 102 and allows device 72 to be detached from coupler 102. Alternatively, a lever (not shown) may be provided to perform the same function as button 110.

In another embodiment, quick-connect coupler 102 includes receiving points 112, which are in the form of indentations 112. Indentations 112 are positioned to accommodate spring biased detents 96 by allowing biased detents 96 to extend into indentations 112 thereby retaining quick-connect coupler 102 in receiving channel 90. The interaction of biased detents 96 and indentations 112 allow the removal of keyboard device 72 from quick-connect coupler 102 by the application of an appropriate pulling force on keyboard device 72. Receiving points 112 may also be in the form of holes into which biased detents 96 extend. Alternatively, biased detents 96 may be positioned on quick-connect coupler 102 and indentations 112 along receiving channel 90 to thereby removably retain keyboard device 72 to quick-connect coupler 102.

Alternatively, quick-connect coupler 102 may interact with receiving channel 90 to retain keyboard device 72 using an interference fit arrangement. This arrangement is arrived at by the shaping and sizing of quick-connect coupler 102 and receiving channel 90 to come into frictional engagement with each other when coupled together.

Attachment assembly 74 may also include a clamping device 116. Mounting bracket 106 moves in a sliding fashion through a portion of clamping device 116. Mounting bracket 106 has a hollow channel or a cavity through which cord 40 is threaded. Pivoting point 118 allows mounting arm 104 to pivot thereabout relative to mounting bracket 106. Clamping device 116 detachably clamps attachment assembly 74 to an edge of desk top 18.

In FIG. 5, there is shown attachment assembly 74 substantially similar to the previous embodiment of the present invention, interacting with track 108. Mounting bracket 106 is detachably slidingly connected to track 108. Track 108 is secured with fasteners to an underneath side of desktop 18.

Advantageously, attachment assembly 74 interacts with either clamping mechanism 116 or track 108. When attachment assembly 74 is slid into clamping device 116 or track 108, mounting arm 104 aligns with clamping device 116 or track 108 and is substantially in line with mounting bracket 106. As keyboard device 12 is slid from either clamping device 116 or track 108 mounting bracket 106 is freed to pivot about pivot point 118 thereby allowing an operator to position keyboard device 12 at an angle to desktop 18.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A keyboard assembly, comprising:
a keyboard; and
an attachment assembly detachably coupled directly to said keyboard and couplable to a structural member, said attachment assembly completely supporting said keyboard.

2. The keyboard assembly of claim 1, wherein said keyboard includes at least one receiving channel at least partially within said keyboard, said attachment assembly at least partially engaging said receiving channel.

3. The keyboard assembly of claim 2, wherein said keyboard and said attachment assembly are detachably coupled by way of at least one of an interference fit, at least one biased finger and at least one spring loaded detent.

4. The keyboard assembly of claim 3, wherein at least one of said keyboard and said attachment assembly includes said at least one biased finger.

5. The keyboard assembly of claim 1, wherein said attachment assembly further comprises a quick connect coupler that is detachably coupled with said keyboard.

6. The keyboard assembly of claim 5, wherein said quick connect coupler is releasable from said keyboard by way of at least one of depressing a button, activating a lever and a pulling motion.

7. The keyboard assembly of claim 1, wherein said keyboard is an integral keyboard device including:
a keyboard pad support;
a keyboard pad; and
a wrist rest.

8. The keyboard assembly of claim 7, wherein said integral keyboard device includes a mouse pad.

9. The keyboard assembly of claim 1, wherein said attachment assembly includes at least one mounting arm removably coupled with one of a receiving channel within said keyboard and a protrusion extending from said keyboard.

10. The keyboard assembly of claim 9, wherein said attachment assembly further includes a mounting device pivotally attached to said mounting arm.

11. The keyboard assembly of claim 10, wherein said attachment assembly includes at least one track slidably attached to said mounting device, said at least one track being configured for attachment to an underside of a work surface.

12. A computer peripheral assembly, comprising:
a data input device having at least one receiving channel; and
an attachment assembly directly coupled with at least one said receiving channel, said attachment assembly configured for attaching to a work surface.

13. The assembly of claim 12, wherein said data input device is strengthened to accommodate at least approximately 30 pounds of force placed at a point on said data input device remote from said receiving channel.

14. The assembly of claim 12, wherein said attachment assembly includes a quick-connect coupler configured for being attached to and detached from said data input device.

15. The assembly of claim 14, further comprising a cord attached to said data input device, said attachment assembly including a retaining device retaining said cord.

16. The assembly of claim 15, wherein said attachment assembly includes a mounting arm attached to said quick-connect coupler, said mounting arm including a channel retaining said cord.

17. The assembly of claim 14, wherein said attachment assembly is configured for enabling pivotal movement of said data input device relative to said work surface.

18. A method of supporting a computer input device, comprising the steps of:
providing a data input device having at least one receiving channel; and
directly coupling said data input device to an attachment assembly by way of at least one said receiving channel.

19. The method of claim 18, wherein said receiving channel is at least partially contained within said data input device.

20. The method of claim 19, wherein said coupling step, includes the sub-step of removably coupling said data input device to said attachment assembly by at least one of an interference fit, at least one biased finger and at least one spring loaded detent.
